(19) United States
(12) Patent Application Publication
(10) Pub. No.: US 2016/0284006 A1
(43) Pub. Date: Sep. 29, 2016

(54) SYSTEM AND METHOD FOR ADVERTISING ITEMS

(71) Applicant: ARGADNEL VENTURES LIMITED, Castletown (IM)

(72) Inventors: MICHAEL ANTHONY ASHLEY OSBORNE, Ballasalla (IM); Hazel Elizabeth Osborne, Ballasalla (IM); Ashley James Edward Osborne, Douglas (IM); Nicholas Robinson Horsthuis, Baldrine (IM)

(73) Assignee: ARGADNEL VENTURES LIMITED, Castletown (IM)

(21) Appl. No.: 14/812,838

(22) Filed: Jul. 29, 2015

(30) Foreign Application Priority Data
Mar. 27, 2015 (GB) 1505328.3

(51) Int. Cl. G06Q 30/06

(52) U.S. Cl. CPC G06Q 30/0631; G06Q 30/0635

(57) ABSTRACT

A system for advertising items which are close to their expiry dates, the system comprising: a merchant device configured to upload information about an item which is close to its expiry date; a service provider server configured to receive the uploaded information and to store the uploaded information in an item database; and a user device configured to receive at least part of the uploaded information from the item database, to receive a user's selection of the item, and to transmit a reserve request to the service provider server, wherein the service provider server is further configured to forward the reserve request to the merchant device such that the item is reserved for the user.

### BACKGROUND

1. Field of the Invention

Embodiments of the present invention relate to a system and method for advertising items which may be close to their expiry dates, along with a user device, a merchant device, and a service supply server, and applications executable on the devices and server.

2. Description of the Related Art

Various mechanisms have been developed in order to provide potential customers with information about offers for discounted goods and services. These include, for example, notifications which are sent to users by email and webpages which include lists of offers.

It is common for retailers and service providers to overstock goods and the supplies for the provision of services accidentally based on inaccurate predictions of demand. In some instances, these goods and supplies are perishable and may have a relatively short shelf life. Other examples, the goods and supplies may include, for example, publications (such as newspapers and magazines but also books) which will shortly be replaced by a new edition.

In some instances, goods or services may be ordered by a retailer or prepared for/reserved by a service provider in response to a specific customer request—examples include a ticket for use in relation to a transportation service (such as for a flight or a rail journey), tickets for shows and other events, hotel rooms or other accommodation, rental vehicles, and tables at a restaurant or other food service venue. However, if the customer cancels the goods or services, or does not make the appointed time for the provision of the goods or services, then the goods and services may be not be utilised.

Therefore, such retailers and service providers will be faced with the prospect of having to dispose of the overstocked goods and supplies as waste (e.g. in the rubbish or trash). In some situations, the retailer or service provider may even have to pay for the disposal of the goods and supplies which have been overstocked and which cannot be sold or used before they expire (and can no longer be sold or used). In some examples in which the customer cancels an order for goods or services, or does not make the appointed time of the provision of the goods or services, then the customer may still be charged for the goods and services. Nevertheless, the retailer and/or service provider may still, in such examples, be financially disadvantaged because they may expect to make additional revenue from associated sales (for example, someone travelling on an aeroplane (i.e. “airplane”) or attending an event may be expected to purchase food or drink). In addition, for example, empty seats at events can negatively impact the other customers' experience of the event and can negatively impact the perceived popularity of the venue and/or the event.

Conventionally, a retailer or service provider, on determining that they will have a likely oversupply of goods or supplies which cannot be sold or used in time, will decrease the price of those goods or the services to which the supplies relate. By decreasing the price, the retailers and service providers hope that the goods or supplies will be used before they expire, and any loss which would otherwise be made in relation to the disposal of the goods and supplies can be minimised (and, perhaps, even a small profit made in some instances).

Typically, retailers will, for example, apply discount stickers to goods which are due to expire imminently. A discount sticker may indicate a discounted price and may, for example, be a bright colour in order to catch potential customer's eye. In some examples, retailers will place the discounted goods in special areas of their outlets.

Unless potential customers enter the retailer's outlets, then they may be unaware of the discounted goods. A similar issue arises with supplies which are used in the provision of services. As a result potential customers may miss discounted goods and services. This increases the risk of goods and supplies having to be disposed of as waste.

The need to dispose of goods and supplies has a financial implication for the retailer or service provider. There is also, however, an environmental impact—as the disposal is often to landfill sites. In addition, although many such perishable goods and supplies are biodegradable, the packaging may not be biodegradable and/or may have consumed valuable resources in its manufacture.

Although some packaging may be recyclable, it is not uncommon for goods and supplies from commercial sources (e.g. retailers and service suppliers) not to be processed by recycling services and/or for recycling services to find it difficult or impossible to handle packaged perishable goods and supplies.

The resale of goods which were specifically ordered on the request of a customer and/or services which a customer has cancelled or missed is also conventionally difficult.

Therefore, embodiments of the present invention seek to ameliorate one or more problems associated with the prior art.

### SUMMARY OF THE INVENTION

Accordingly, an aspect of the present invention provides a system for advertising items which are close to their expiry dates, the system comprising: a merchant device configured to upload information about an item which is close to its expiry date; a service provider server configured to receive the uploaded information and to store the uploaded information in an item database; and a user device configured to receive at least part of the uploaded information from the item database, to receive a user's selection of the item, and to transmit a reserve request to the service provider server, wherein the service provider server is further configured to forward the reserve request to the merchant device such that the item is reserved for the user.

The service provider server may be further configured to receive a plurality of reserve requests and to process the plurality of reserve requests in a bid manager to determine a winning reserve request, wherein the winning reserve request is the reserve request which is forwarded to the merchant device.

The expiry date may be the date on which the at least part of the uploaded information is received by the user device.

The merchant device may be a mobile computing device.

The user device may be a mobile computing device.

The user device may include a location module which is configured to determine the location of the user device and wherein the user device is further configured to request information about the item based on a proximity of a location of the item to the determined location of the user device.

The location module may be configured to upload the determined location to the service provider server and the service provider server is configured to send information about the number of user devices within a predetermined range of the merchant device to the merchant device.

The merchant device may be further configured to receive transaction information from the service provider server in response to the item being reserved for purchase, and the user device is configured to prompt for entry of the transaction information during a transaction for the item between the user and the merchant, such that the transaction information is enterable into the user device and the user device is further configured to send the transaction information to the service provider server to confirm the transaction.

The merchant device may include an image capture device which is configured to capture an image of the item and wherein the information which is uploaded includes the image of the item.

The at least part of the uploaded information which is received by the user device may include the image of the item.

The user device, the merchant device, and the service provider server may be communicatively coupled to each other over a network which includes the Internet.

Another aspect provides a method for advertising items which are close to their expiry dates, the method comprising: upload information about an item which is close to its expiry date using a merchant device; receiving the uploaded information and storing the uploaded information in an item database using a service provider server; receiving at least part of the uploaded information from the item database using a user device; receiving a user's selection of the item at the user device; transmitting from the user device a reserve request to the service provider server; and forwarding the reserve request from the service provider server to the merchant device such that the item is reserved for the user.

The expiry date may be the date on which the at least part of the uploaded information is received by the user device.

The merchant device may be a mobile computing device.

The user device may be a mobile computing device.

The method may further comprise: determining the location of the user device using a location module of the user device; and requesting information about the item using the user device based on a proximity of a location of the item to the determined location of the user device.

The method may further comprise: using the location module to upload the determined location to the service provider server; and sending, using the service provider server, information about the number of user devices within a predetermined range of the merchant device.

The method may further comprise: receiving transaction information from the service provider server in response to the item being reserved for purchase; prompting, at the user device, for entry of the transaction information during a transaction for the item between the user and the merchant; entering the transaction information into the user device; and sending the transaction information from the user device to the service provider server to confirm the transaction.

The method may further comprise: using an image capture device of the merchant device to capture an image of the item, wherein the information which is uploaded includes the image of the item.

The at least part of the uploaded information which is received by the user device may include the image of the item.

The user device, the merchant device, and the service provider server may be communicatively coupled to each other over a network which includes the Internet.

Another aspect provides a non-transitory computer readable medium having instructions stored thereon in the form of a client application which, when executed by a processor of a user device, cause the user device to: transmit a request for information from a service provider server about an item which is close to its expiry date; receive information from the service provider server about the item; receive a user's selection of the item; and transmit a reserve request to the service provider server.

The expiry date may be the date on which the information is received by the user device.

The user device may be a mobile computing device.

The non-transitory computer readable medium, wherein the instructions, when executed by the processor, may further cause the user device to: determine a location of the user device; and request information about the item based on a proximity of a location of the item to the determined location of the user device.

The non-transitory computer readable medium, wherein the instructions, when executed by the processor, may further cause the user device to: upload the determined location to the service provider server.

The non-transitory computer readable medium, wherein the instructions, when executed by the processor, may further cause the user device to: receive information from the service provider server about the item including an image of the item.

The non-transitory computer readable medium, wherein the instructions, when executed by the processor, may further cause the user device to: connect to the service provider server over a network which includes the Internet.

The non-transitory computer readable medium, wherein the instructions, when executed by the processor, may further cause the user device to: display a request for the entry of transaction information; receive entered transaction information in response to the displayed request; and transmit the transaction information to the service provider server to confirm the transaction has occurred.

Another aspect provides a non-transitory computer readable medium having instructions stored thereon in the form of a merchant application which, when executed by a processor of a merchant device, may cause the merchant device to: upload information to a service provider server about an item which is close to its expiry date; and receive a reserve request for the item from the service provider server.

The expiry date may be the date on which the information is uploaded by the merchant device.

The merchant device may be a mobile computing device.

The non-transitory computer readable medium, wherein the instructions, when executed by the processor, may further cause the merchant device to: determine a location of the merchant device; and upload information to a service provider server about the item which is close to its expiry date including the determined location of the merchant device.

The non-transitory computer readable medium, wherein the instructions, when executed by the processor, may further cause the merchant device to: capture an image of the item; and upload information to a service provider server about the item which is close to its expiry date including the captured image of the item.

The non-transitory computer readable medium, wherein the instructions, when executed by the processor, may further cause the merchant device to: connect to the service provider server over a network which includes the Internet.

The non-transitory computer readable medium, wherein the instructions, when executed by the processor, may further cause the merchant device to: receive transaction information from the service provider server such that the merchant can provide the transaction information to a user device; and receive confirm of the completion of the transaction from the service provider server in response to the merchant providing the transaction information to the user device.

Another aspect provides a non-transitory computer readable medium having instructions stored thereon in the form of a service provider application which, when executed by a processor of a service provider server, cause the service provider server to: receive uploaded information from a merchant device about an item which is close to its expiry date; store the uploaded information in an item database; send at least part of the uploaded information from the item database to a user device; receiving a reserve request from the user device in relation to the item; and forwarding the reserve request to the merchant device such that the item is reserved for the user.

The expiry date may be the date on which the at least part of the uploaded information is received by the user device.

The non-transitory computer readable medium wherein the instructions, when executed by a processor of a service provider server, may further cause the service provider server to: receive a location of the user device; and send information about the item to the user device based on a proximity of a location of the item to the location of the user device.

The non-transitory computer readable medium wherein the instructions, when executed by a processor of a service provider server, may further cause the service provider server to: send transaction information to the merchant device in response receipt of the reserve request; and receiving the transaction information from the user device to confirm the transaction.

The non-transitory computer readable medium wherein the instructions, when executed by a processor of a service provider server, may further cause the service provider server to: receive an image of the item as part of the uploaded information.

The non-transitory computer readable medium wherein the instructions, when executed by a processor of a service provider server, may further cause the service provider server to: send the at least part of the uploaded information including the image of the item.

The non-transitory computer readable medium wherein the instructions, when executed by a processor of a service provider server, may further cause the service provider server to: connect to the user device and the merchant device over a network which includes the Internet.

### BRIEF DESCRIPTION OF THE DRAWINGS

Embodiments of the present invention are described, by way of example only, with reference to the accompanying drawings, in which:

FIG. 1 shows a schematic view of a system of embodiments; and

FIGS. 2 to 10 show example graphical user interface screens produced by user and merchant applications of embodiments.

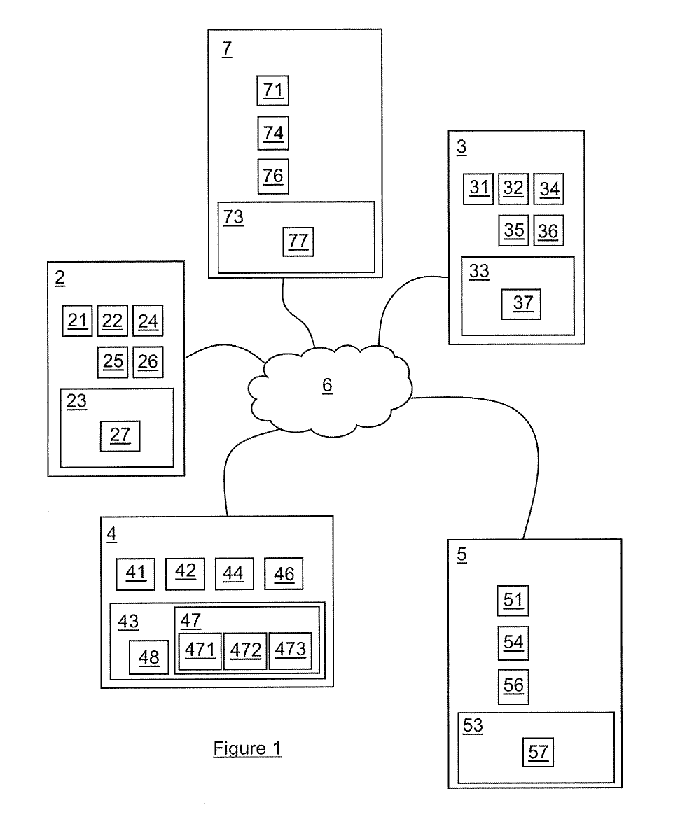

### DETAILED DESCRIPTION OF THE INVENTION

Accordingly, embodiments of the present invention include a system 1 which includes a user device 2, a merchant device 3, and a service provider server 4.

The user device 2, merchant device 3, and service provider server 4 are communicatively coupled via a network 6, which may include the Internet. The merchant device 3 is configured to provide a mechanism by which merchants can upload information about one or more discounted items to the service provider server 4 and the user device 2 is configured to receive the information about the one or more discounted items.

In some embodiments the user device 2 may be a mobile (i.e. cellular) telephone. In some embodiments, the user device 2 may be another form of mobile computing device (such as a tablet computer or a laptop computer or a smart watch). In some embodiments, the user device 2 may be a substantially immobile computing device (such as a desktop computer). Accordingly, the user device 2 may be a computing device which can take a number of different forms. In some embodiments, the user device 2 is a communicatively coupled collection of two or more devices (e.g. a mobile telephone and a smart watch) such that information for display on the user device 2 may be displayed on a particular one of the collection of devices in accordance with user preferences and/or application settings.

In some embodiments, the system 1 includes a plurality of user devices 2 which may include one or more user devices 2 which are of a different form to one or more others of the user devices 2.

The or each user device 2 may include a user device interface 21 which is configured to receive inputs from the user. The user device interface 21 may include one or more buttons which are actuatable by the user.

The or each user device 3 may include a user device display 22 which is configured to display information to the user. The user device display 22 may include, for example, a liquid crystal display screen or another other suitable display.

In some embodiments, the user device interface 21 and user device display 22 are integrated, such that the user device display 22 and user device interface 21 are embodied in a touch-sensitive screen.

The user device 2 includes a user device processor 24 which is configured to process one or more instructions which may be stored in a user device memory 23 of the user device 2. The user device processor 24 may be further configured to receive one or more signals from the user device interface 21 in response to inputs received from the user. The user device processor 24 may be further configured to output one or more signals to the user device display 22 in order to cause the display of information to the user.

In some embodiments, the user device 2 may include a user device location module 25 which is configured to determine a geographical location of the user device 2. The geographical location may be an approximate location (e.g. a town or city) or may be a more accurate location (such as longitude and latitude with an accuracy of 20 m or less). The user device location module 25 may take many different forms and can use a combination of techniques to determine the geographical location.

In some embodiments, the user device location module 25 is configured to cause the output on the user device display 22 of a request for the user to enter their geographical location using the user device interface 21. The user may be prompted, for example, to enter one or more of a region (such as a county or state), a city/town, a district of a city/town, a postal code (such as a zip code), a house/building number, or the like. The entered information in response to the output request may then be used as the geographical location or in the process of determining the geographical location. In some embodiments, this may not be the actual geographical location of the user device 2 but may be a planned future location of the user device 2 (such as a stopping point on a journey).

In some embodiments, the user device location module 25 may include a receiver for a satellite-based geographical location determining system. The user device location module 25 may, therefore, include a Global Positioning System receiver and/or a GLOSNASS receiver and/or a Galileo receiver. As will be appreciated, the user device location module 25 may include a receiver for other such satellite-based geographical location determining systems. In such embodiments, the user device location module 25 may be configured to determine the geographical location of the user device 2 with a relatively high degree of accuracy. As will also be appreciated, the accuracy (or even the entire operability) of such systems may be influenced by a number of different factors including the weather conditions and any building structures or the like which are close to the user device 2.

In some embodiments, the user device location module 25 may be configured to determine the geographical location based on one or more cellular communication base stations to which the mobile device 2 is connected (as described below in relation to a user device network interface 26). The user device location module 25 may use the identity of one base station to which the mobile device 2 is communicatively connected in order to determine an approximate geographical location. In some embodiments, the user device location module 25 is configured to use the strength of signals received from one or more such base stations to determine a more accurate geographical location. As will be appreciated, such techniques can be prone to environmental issues and can be inaccurate in built-up areas—in which there are a number of convoluted signal paths between the or each base station and the mobile device 2. In some such embodiments, the or each base station may transmit its location to the mobile device 2.

In some embodiments, the user device location module 25 may be configured to determine the geographical location based on one or more data networks to which the mobile device 2 is connected (as described below in relation to a user device network interface 26). The or each data network may, for example, comprise a wireless network such as a Wifi network. The user device location module 25 may determine the identity of the data network or a node of the network to which the user device 2 is connected. This identity may be compared to record of network identities and associated locations which is available to the user device location module 25 and which may be provided via the data network and/or via the cellular communication base station.

In some embodiments, the user device location module 25 is configured to determine the geographical location based on one or more beacons which can be detected by the mobile device 2. For example, the or each beacon may be a short range wireless beacon—such as a Bluetooth beacon (which may be an iBeacon). The user device 2 may be configured to receive one or more wireless signals from the or each beacon via the user device network interface 26 (see below) and to pass information derived from the or each wireless signal to the user device location module 25. The location may use the derived information to determine the location of the or each beacon and, hence, the geographic location of the user device 2. The user device location module 25 may be configured to determine the identity of the beacon and to compare this to a record of beacon identities and associated locations which is available to the user device location module 25 and which may be provided via the data network and/or via the cellular communication base station. In some embodiments, the geographical location is received via the or each beacon.

The or each beacon may, for example, be associated with a merchant and may be located in an outlet (e.g. a shop) which is operated by that merchant. A geographical region may include a plurality of merchants with respective outlets and each may include a respective beacon.

In some embodiments, therefore, the geographical location may be the identity of an outlet in which the user device 2 is located (or which the user device 2 is nearby).

In some embodiments, the user device location module 25 may be configured to interrogate ancillary information to determine a likely geographical location. This ancillary information may include one or more calendar entries. In some embodiments, the ancillary information comprises messages received by the user (e.g. at the user device 2) and may include emails, short message service messages, social networking entries, and the like. The ancillary information may include appointments for meetings (with location information included in the entry) or which may include reservation information for food service venues (such as a table at a restaurant), entertainment (such as a concert or play), accommodation (such as a hotel room), and/or travel (such as a flight, car rental) and the like.

The user device location module 25 may use any one or more of the above described techniques to determine the geographical location. In some embodiments, the user device location module 25 is configured to use a combination of the above described techniques by using one technique to narrow down the location determined by anther technique.

As will be understood, some of the above techniques will work better in some environments to others. For example, in the sparsely populated countryside, beacons are unlikely to be present but satellite-based geographical location determining systems are likely to operate well. In cities and other built-up areas, satellite-based geographical location determining systems may not operate effectively but beacons may be more common.

Accordingly, the user device location module 25 may be configured to determine the geographical location using a combination of such techniques and may favour a particular technique in certain conditions.

The user device 2 may include, in some embodiments, the user device network interface 27. The user device network interface 27 may be configured to provide a communicative coupling between the user device 2 and the service provider server 4 (e.g. over the network 6).

In some embodiments, the user device network interface 27 is a data network interface. In some embodiments, the user device network interface 27 includes a wireless and/or a wired network interface.

The wireless network interface may include an interface for communicative coupling to a cellular data network which uses a cellular telephone network infrastructure (including one or more cellular communication base stations) to couple the user device 2 and the service provider server 4. The cellular data network may be coupled to the Internet such that the communicative coupling between the user device 2 and the service provider server 4 is via the cellular data network and the Internet. In some embodiments, the cellular telephone network infrastructure also provides a data network.

The wireless network interface may include an interface for communicative coupling to a Wifi network or other wireless radio network or device (e.g. a Bluetooth device) to couple the user device 2 and the service provider server 4 (via the Internet or otherwise).

The wired network interface may include an interface for communicative coupling to a domestic internet connection which may be provided via asymmetric digital subscriber line, for example. The wired network interface may, therefore, include a modem in some embodiments. In some embodiments, the wired network interface may include an Ethernet connection, which may provide a data network connection to the Internet (e.g. via one or more nodes of the network).

As will be appreciated, therefore, the user device network interface 26 may include a number of different interfaces which are each configured to be communicatively coupled to one or more other devices and/or networks. One or more of these interfaces may be used to connect the user device 2 to the network 6 and, hence, to other parts of the system 1. In some embodiments, these interfaces may be used by, for example, the user device location module 25—see above.

The user device memory 23 may include memory which is used by the user device processor 24 for the temporary storage of instructions and/or data, and may include a non-transitory storage medium for the storage of one or more instructions to control the operation of the user device processor 24.

The user device processor 24 is communicatively coupled to one or more of the user device interface 21, the user device display 22, the user device memory 23, the user device location module 25, and the user device network interface 26.

The user device memory 23 and, in particular, the non-transitory storage medium thereof is configured to store one or more instructions in the form of a user application 27 which, when executed by the user device processor 24, causes the user device 2 to operate in accordance with the user application 27 (which is described below).

The merchant device 3 may be of a similar or identical form the user device 2 and may, therefore, include a merchant device interface 31, a merchant device display 32, a merchant device memory 33, a merchant device processor 34, a merchant device location module 35, and a merchant device network interface 36. The above description in relation to these corresponding parts of the user device 2 applies equally to the commonly named components of the merchant device 3.

In some embodiments, the merchant device 3 is a point of sale system—e.g. a till or cash register. In some embodiments, the merchant device 3 is an accessory to a point of sale system which is configured for communicative coupling to the point of sale system—as such, the merchant device interface 31 may include one or more parts of the point of sale system which are configured to read information in relation to items (e.g. barcode readers and the like). In some embodiments, the accessory to the point of sale system is configured to access other information which is accessible to the point of sale system including, for example, stock level or inventory information, records of the expiry dates of stocked items, and planned future delivery dates for fresh items. The merchant application 37 (see below) may be configured to upload information about one or more items which are approaching their expiry date automatically and/or information about one or more items which are due for replacement in an imminent future delivery.

In the case of the merchant device 3, the merchant device memory 33 and, in particular, the non-transitory storage medium thereof is configured to store one or more instructions in the form of a merchant application 37 which, when executed by the merchant device processor 34, causes the merchant device 3 to operate in accordance with the merchant application 37 (which is described below).

In the case of the merchant device 3, the merchant device interface 31 may include an image capture device such as a camera which is configured to capture images. The image capture device may be configured to capture an image of an item for example. In some embodiments, the image capture device is configured to capture an image of one or more identifying marks on the item or its packaging—such as a brand name, a product name, a barcode, or the like. The image capture device may be configured to capture one or more images of text which may be processed by a text recognition program which may, for example, be executed by the merchant device processor 34 (and which may be stored in the merchant device memory 33 (e.g. on the non-transitory storage medium thereof). The text recognition program may be configured to translate an image of text into a string of characters for further use by the merchant device 3. As will become apparent, the text recognition program and the image capture device may be configured to read brand, product, ingredient, size, weight, volume, number, quantity, expiry date, use before date, best before date, and other information from a product and/or its packaging.

In some embodiments, the merchant device interface 31 may include a barcode reader which is configured to read a barcode and determine an item identifier from the barcode. The barcode reader may include a light source to illuminate the barcode and a detector to receive a reflected light pattern from the barcode—the light source may be located with a scanning mechanism (e.g. a reciprocating mirror) to scan an illuminating beam emitted by the light source across the bar code.

In some embodiments, the merchant device interface 31 may include an RFID tag reader which is configured to detect and read information from one or more RFID tags which are located close to the merchant device 3—the or each RFID tag being associated with an item and including an item identifier.

Accordingly, the merchant device interface 31 may include one or more components which are configured to read information from items.

In some embodiments, the service provider server 4 is communicatively coupled to the network 6 (and hence to the user device 2 and merchant device 3) via a service provider network interface 46 of the service provider server 4. The service provider network interface 46, therefore, may be configured to provide a communicative coupling between the service provider 4 and the user device 2 and the merchant device 3. If a plurality of user devices 2 and/or merchant devices 3 is provided, then all such devices 2,3 may be communicatively coupled to the service provider server 4 via the network 6 in the same manner.

The service provider server 4 may, in some embodiments, include a service provider interface 46 which allows an operator of the service provider server 4 to configure and control aspects of the operation of the service provider server 4. The service provider interface 41 may be configured to receive inputs from the service provider operator. The service provider interface 41 may, therefore, include one or more buttons which are actuatable by the service provider operator.

In some embodiments, the service provider 4 may include a service provider display 42 which is configured to display information to the service provider operator. This information may include details regarding the operation of the service provider server and/or interactions between the or each user device 2 and the service provider server 4 and/or between the or each merchant device 3 and the service provider server 4. The service provider display 42 may include, for example, a liquid crystal display screen or any others suitable display.

In some embodiments, the service provider interface 41 and service provider display 42 are integrated, such that the service provider display 42 and service provider interface 41 are embodied in a touch sensitive screen.

In some embodiments, the service provider interface 41 and service provider display 42 are part of a terminal which is communicatively coupled to the service provider server 4 but which do not actually form part of the service provider 4. The terminal may be remote from the service provider server 4. In some embodiments, the terminal may be communicatively coupled to the service provider server 4 over the network 6 (e.g. via the service provider network interface 46). In some embodiments, this terminal may comprise a mobile computing device (such as a mobile telephone or tablet) and in some embodiments the terminal may comprise a substantially immobile computing device (such as a desktop computer).

In some embodiments multiple terminals are provided such that multiple operators can access the service provider server 4 to control and monitor aspects of the operation thereof.

The service provider server 4 includes a service provider processor 44 which is configured to process or more instructions which may be stored on a service provider memory 43 of the service provider server 4. The service provider processor 44 may be further configured to receive one or more signals from the service provider interface 41 in response to inputs received from the service provider operator. The service provider processor 44 may be further configured to output one or more signals to the service provider display 42 in order to cause the display of information to the service provider operator.

The service provider memory 43 may include memory which is used by the service provider processor 44 for the temporary storage of instructions and/or data, and may include a non-transitory storage medium for the storage of one or more instructions to control the operation of the service provider server 4.

As will be appreciated, therefore, the service provider processor 44 is communicatively coupled to one or more of the service provider interface 41, the service provider display 42, the service provider memory 43, and the service provider network interface 46.

The service provider memory 43 and, in particular, the non-transitory storage medium thereof is configured to store one or more instructions in the form of a service provider application 47 which, when executed by the service provider processor 44, causes the service provider server 4 to operate in accordance with the service provider application 47 (which is described below).

In embodiments, the service provider application 47 includes an account database 471 which is configured to store user and merchant account information and an item database 472 which is configured to store information about one or more items. In some embodiments, the service provider application 47 includes a bid manager 473 which is configured to manage competitive bids for one or more of the items in the item database 472.

The service provider memory 43 and, in particular, the non-transitory storage medium thereof may be configured to store one or more instructions in the form of a messenger application 48 which, when executed by the service provider processor 44, causes the service provider server 4 to operate in accordance with the messenger application 48 (which is described below).

In some embodiments, the account database 471 and item database 472 (and/or the bid manager 473) are not stored on the service provider memory 43 but are stored on a remote storage medium which is remote from the service provider server but accessible to the service provider server over the network 6 (e.g. via the service provider network interface 46).

In some embodiments, the system 1 further includes a social network server 5. The social network server 5 may include an application programming interface (API) 51. The API 51 may be communicatively coupled to the network 6 and, via the network 6, to one or more of the user device 2, the merchant device 3, and the service provider server 4.

The social network server 5 includes a social network processor 51 and a social network memory 53. The social network processor 54 is configured to process one or more instructions which may be stored on the social network memory 53 of the social network server 5.

The social network memory 53 may include memory which is used by the social network processor 54 for the temporary storage of instructions and/or data, and may include a non-transitory storage medium for the storage of one or more instructions to control the operation of the social network processor 54.

Social network server 5 may further include a social network interface 56 which is coupled to the API 51 and which is configured to provide connectivity to the network 6.

The social network memory 53 and, in particular, the non-transitory storage medium thereof is configured to store one or more instructions in the form of a social network application 57 which, when executed by the social network processor 54, causes the social network server 5 to operate in accordance with the social network application 57 (which is described below).

In some embodiments, the system 1 further includes a courier server 7. The courier server 7 may include a courier application programming interface (API) 71. The courier API 71 may be communicatively coupled to the network 6 and, via the network 6, to one or more of the user device 2, the merchant device 3, the service provider server 4, and the social network server 5.

The courier server 7 includes a courier server processor 71 and a courier server memory 73. The courier server processor 74 is configured to process one or more instructions which may be stored on the courier server memory 73 of the courier server 7.

The courier server memory 73 may include memory which is used by the courier server processor 74 for the temporary storage of instructions and/or data, and may include a non-transitory storage medium for the storage of one or more instructions to control the operation of the courier server processor 74.

Courier server 7 may further include a courier server network interface 76 which is coupled to the courier API 71 and which is configured to provide connectivity to the network 6.

The courier server memory 73 and, in particular, the non-transitory storage medium thereof is configured to store one or more instructions in the form of a courier application 77 which, when executed by the courier server processor 74, causes the courier server 7 to operate in accordance with the courier application 77 (which is described below).

The merchant application 37 may, on initiation or on selection, be configured to present to the merchant on the merchant device display 32 a request for login information.

The login information may include, for example, a user name and password. The merchant may input this information into the merchant device 3 via the merchant device interface 31.

The merchant application 37 may be configured to compare the login information which is received from the merchant against login information which is stored locally in the merchant device 3 (e.g. on the merchant device memory 33) and/or may be configured to transmit all or part of the login information to the service provider server 4 (via the network 6).

In response to receipt of all or part of the login information, the service provider server 4 and, in particular, the service provider application 47 may be configured to compare the received information with information stored in the account database 471. This may include a comparison of all of the login information (e.g. a user name and password) received by the service provider server 4 with login information stored in the account database 471 to determine whether or not the merchant is authorised to use the system 1. In some embodiments, confirmation of the authorisation (or an authorisation failure as the case may be) is sent by the service provider server 4 (e.g. under instruction from the service provider application 47) to the merchant device 3 (e.g. over the network 6).

In some embodiments, the comparison includes the identification of further information associated with an account for which information is stored in the account database 471, wherein that further information may be sent back to the merchant device 3 (e.g. over the network 6) such that the merchant device 3 (e.g. the merchant application 37) can compare the further information with a part of the login information which was not sent to the service provider server 4. Accordingly, for example, the login information which is sent to the service provider server 4 may include a username and the returned further information may be all or part of a password associated with that username. As will be appreciated, therefore, the merchant device 3 may, in some embodiments, be configured to confirm the authorisation of the merchant to use the system 1 (or an authorisation failure as the case may be).

Authorisation of the merchant to use the system 1 may include determining an identifier for the merchant, in relation to which account information is stored in the account database 471 and/or the merchant device 3. The identifier may be included in the login information (e.g. a username) or may be supplied by the merchant device 3 in some other manner (e.g. the identifier may be an identifier associated with the merchant device 3). The account information may include, for example, one or more items which are associated with the merchant and/or which have previously been associated with the merchant.

The account information may include, for example, one or more of the identity of the merchant, the name of an outlet with which the merchant is associated, a brand name associated with the outlet and/or the merchant, an address for the merchant's outlet, a telephone number for the merchant's outlet and/or the merchant, an email address for the merchant and/or the merchant outlet, social networking account information for the merchant and/or the merchant outlet, and geographical location information for the merchant outlet.

On the merchant application 37 successfully determining (whether itself or through the service provider server 4) the authorisation of the merchant to use the system 1, then the merchant device 3 may be configured to upload to the item database 472 (under instructions from the merchant application 37) information about one or more items and/or services. The merchant application 37 may, for example, be configured to display (e.g. on the merchant device display 42) a request for the uploading of information about one or more items and/or services.

In particular, the merchant device 3 may be configured to receive input from the merchant (e.g. via the merchant device interface 31) which includes the details of one or more items. The details may include, for example, one or more of the type of item, a brand name associated with the item, a product name for the item, a manufacturer of the item, size, weight, volume, number, quantity, ingredient information for the item, nutritional information for the item, one or more expiry dates associated with the item (which may include a use by date and/or a display until date, and/or a best before date and/or a sell by date and/or an open date), the location of the item, the time, date and/or period at which the item will be available, the current time and/or date (i.e. the time and/or date on which details of the one or more items are being advertised using the system 1), a photograph of the item, and price information for the item.

In some embodiments, the merchant device 3 may be configured to receive input from the merchant (e.g. via the merchant device interface 31) which includes an indication of whether the one or more items for which the merchant has input details are open to competitive bidding by users. In such examples, the merchant may further input details (e.g. via the merchant device interface 31) indicating an auction type (e.g. blind or open) and/or a reserve price for the or each item.

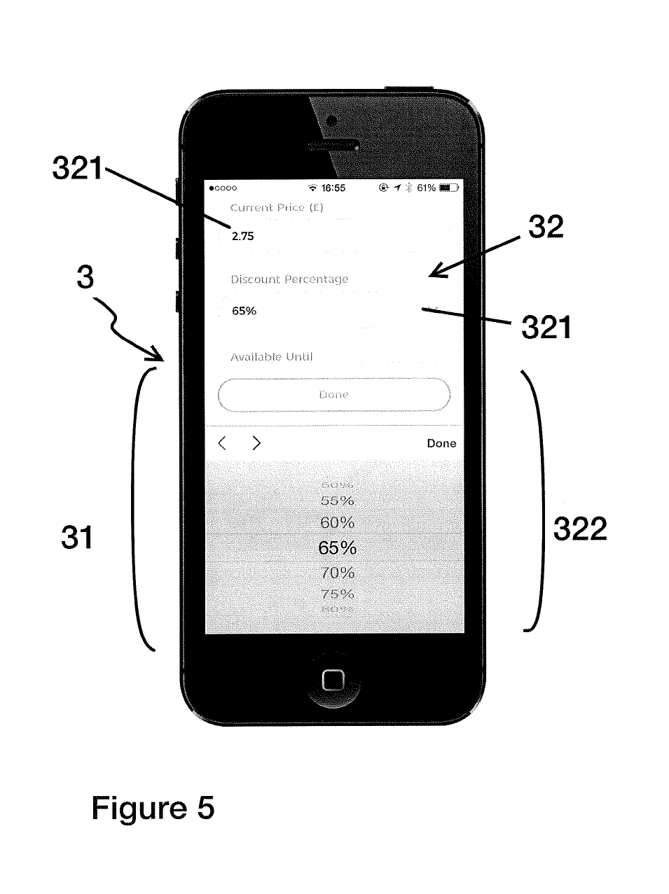

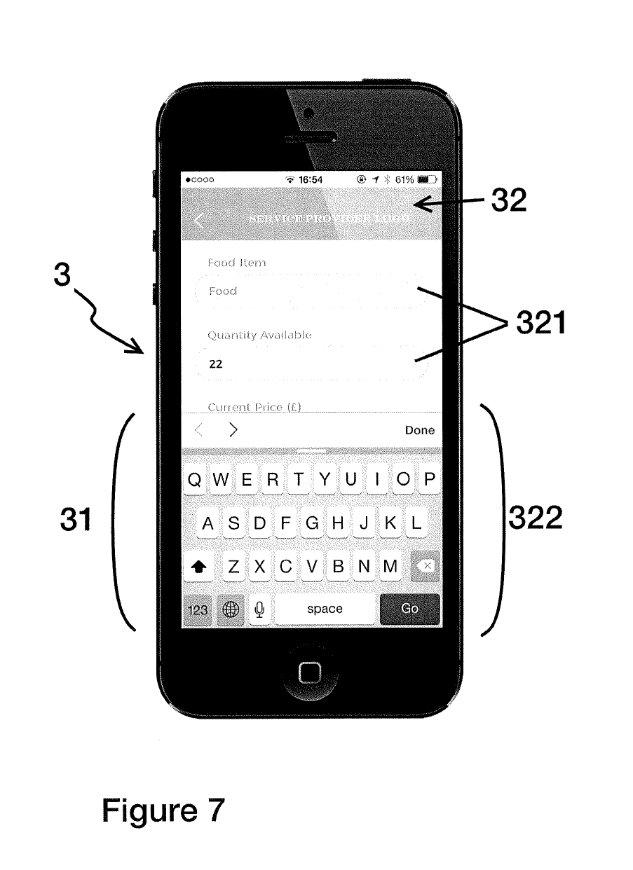

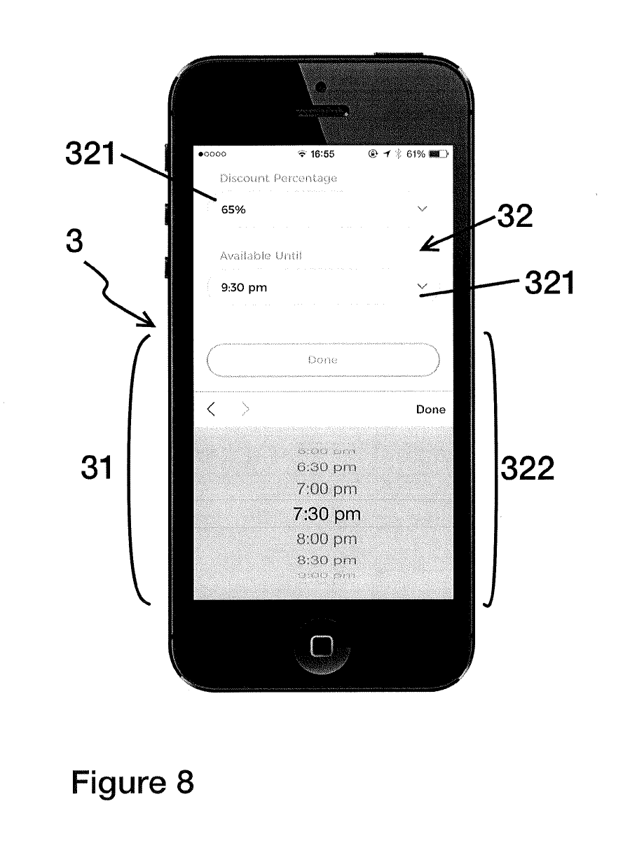

FIGS. 5, 7, and 8 show example graphical user interface screens displayed on the merchant device display 32. The screens may display a number of fields 321 for the entry of information regarding the or each item and one or more mechanisms 322 by which the merchant can enter the information (such as scrolling numbers and buttons)—this is part of the merchant device interface 31.

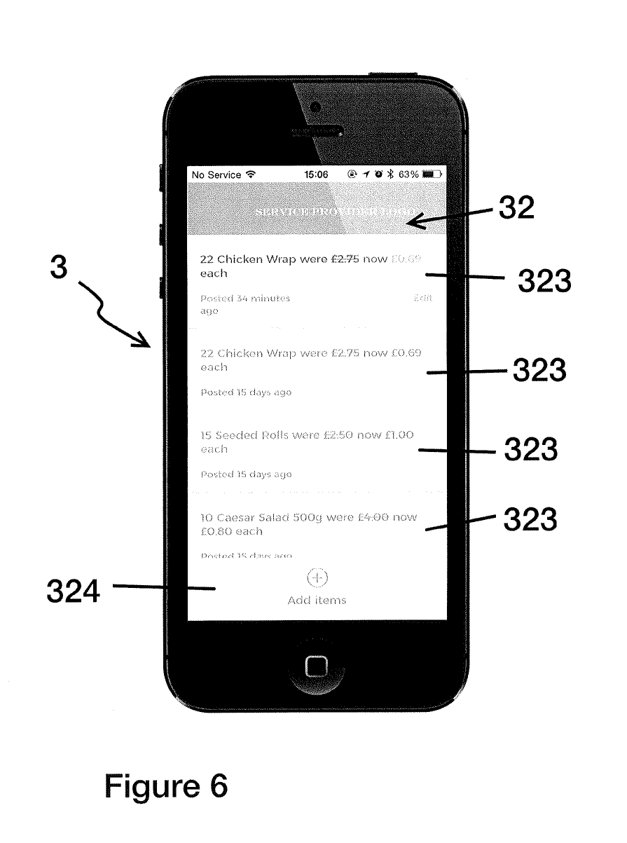

FIG. 6 shows an example graphical user interface screen displayed on the merchant device display 32. The screen may display details 323 for the or each item which the merchant has advertised using the system 1 and a user actuatable button 324—which is part of the merchant device interface 31—to allow the merchant to add information about one or more further items (which may result in the display of a screen such as shown in FIG. 5 or 7 or 8). The screen may also permit the selection of existing information for an item and the editing of that information.

As will be apparent, the merchant device interface 31 may include various different components which allow this information to be entered into the merchant device 2 for upload (e.g. the image capture device, the barcode reader, and/or the RFID tag reader).

The expiry date may be, as will be understood from the preceding paragraph, a date by which the item should be sold, opened, used, or the like in order to ensure that the item is of the intended quality and/or is safe to use.

Such items may be generally referred to as “products”. In some instances, the or each item is an item which is used in the provision of a service. In some embodiments, the item is an instance of a service (e.g. a ticket for a journey, a seat allocation, a hotel room reservation, the provision of a rental vehicle, etc.). In some embodiments, the input received from the merchant by the merchant device 3 may include details of the service to which the item relates—including, for example, the type of service, the extent or duration of the service, available time and/or date slots for the provision of the service, the location at which the service is available, the service cost (i.e. price information for the service), the class of service (e.g. standard or “coach” class, business class, first class, etc.), a seat location, and the like. Such services could include events (such as a concert or play), travel (such as a flight or train or vehicle rental), a restaurant booking, accommodation, or the like. These may include services which have become available due to a cancellation or missed time for the services.

The merchant may use the image capture device of the merchant device interface 31 to capture an image of the whole or part of the item. This may include one or more labels on the item and the text recognition program may be configured to identify text within the or each image, and determine a string of characters which may comprise any of the information discussed above which the merchant device 3 may be configured to receive from the merchant 3. Similarly, the merchant may use the barcode reader of the merchant device interface 31 to read a barcode associated with the item and/or the RFID tag reader to read an RFID tag associated with the item.

The merchant device 3, via the merchant application 37, may be configured to upload information about the or each item and/or service to the service provider server 4. The uploaded information may include any or all of the information which the merchant device 3 receives from the merchant through the merchant device interface 31.

So, for example, details of the or each item and/or service may be uploaded by the merchant application 37 to the service provider server 4 and those details may be sufficient to allow a user to identify the or each item and/or service, and may include price information. The details also include the location where the or each item and/or service is available (which may be provided by the merchant device location module 35). The details may also include one or more properties of the or each item and/or service to allow the user to assess the item and/or service (e.g. ingredient information and/or nutritional information and/or size and/or weight and/or volume and/or number and/or quantity).

On receipt of the uploaded information from the merchant device 3, the service provider server 4 (e.g. the service provider application 47) may be configured to store the uploaded information (or at least part thereof) in the item database 472. The uploaded information in the item database 472 may be arranged in accordance with one or more categories of information (such as the type of item (e.g. food, drink, etc), the expiry date, or the like)

Accordingly, the item database 472 may be populated by one or more merchants using their respective merchant devices 3.

All or part of the uploaded information may also be stored in the account database 471 in association with the merchant as merchant account information. In some embodiments, the addition of information to the item database 472 may also cause (under the control of the service provider application 47) the addition of links to, or an abbreviated form of that information in the merchant account information for the merchant who uploaded the information for the item database 472. Accordingly, the merchant account information may include links to items for which that merchant has information in the item database 472 or a summary of the items for which that merchant has information in the item database 472.

If the merchant has indicated that one or more items are to be open to competitive bidding by the users, then information from the item database 472 for the or each item may be sent (under the control of the service provider application 47) to the bid manager 473 and/or a link to, or abbreviated form of, that information may be sent to the bid manager 473. This information may include the auction type and/or the reserve price.

A merchant may, therefore, use the merchant device 3 to enter information about one or more items and/or services which the merchant wants to be advertised for sale using the system 1. These one or more items may include perishable items which are approaching their expiry date and which, therefore, the merchant is keen to sell (or otherwise use in the provision of services) as quickly as possible even if at a significant discount. Accordingly, the price information which may be uploaded by the merchant may be discounted price information of the one or more items and/or services. In some instances, this is represented by a relative discount—i.e. a percentage or fraction indicating the relative price reduction. In other instances, this may be an absolute discount—i.e. the actual sum of money which has been deducted from the normal price of the or each item and/or service.

As will be appreciated, in addition to information to allow a user to identify the or each item and/or service being advertised through the system 1 (and possibly also price information), the merchant may upload, using the merchant device 3, location information of the or each item and/or service such that the user can see where the item and/or service on offer is located.

The user application 27 may, on initiation or on selection, be configured to present to the user on the user device display 22 a request for login information.

The login information may include, for example, a user name and password. The user may input this information into the user device 2 via the user device interface 21.

The user application 37 may be configured to compare the login information which is received from the merchant against login information which is stored locally in the merchant device 3 (e.g. on the merchant device memory 33) and/or may be configured to transmit all or part of the login information to the service provider server 4 (via the network 6).

In response to receipt of all or part of the login information, the service provider server 4 and, in particular, the service provider application 47 may be configured to compare the received information with information stored in the account database 471. This may include a comparison of all of the login information (e.g. a user name and password) received by the service provider server 4 with login information stored in the account database 471 to determine whether or not the user is authorised to use the system 1. In some embodiments, confirmation of the authorisation (or an authorisation failure as the case may be) is sent by the service provider server 4 (e.g. under instruction from the service provider application 47) to the user device 2 (e.g. over the network 6).

In some embodiments, the comparison includes the identification of further information associated with an account for which information is stored in the account database 471, wherein that further information may be sent back to the user device 2 (e.g. over the network 6) such that the user device 2 (e.g. the user application 27) can compare the further information with a part of the login information which was not sent to the service provider server 4. Accordingly, for example, the login information which is sent to the service provider server 4 may include a username and the returned further information may be all or part of a password associated with that username. As will be appreciated, therefore, the user device 2 may, in some embodiments, be configured to confirm the authorisation of the user to use the system 1 (or an authorisation failure as the case may be).

Authorisation of the user to use the system 1 may include determining an identifier for the user, in relation to which account information is associated. This account information may include, for example, one or more preferences of the user (and/or a record of their historic usage of the system 1). The account information may be stored in the account database 471 and/or the user device 2.

The account information may include, for example, one or more of the identity of the user, a telephone number for the user, an email address for the user, and social networking account information for the user.

On the user application 27 successfully determining (whether itself or through the service provider server 4) the authorisation of the user to use the system 1, then the user device 2 may be configured to send (under instructions from the user application 27 and using the user device location module 25) the geographical location of the user device 2 to the service provider server 4—this may be stored as part of the user account information for that user and stored, therefore, in the account database 471. This geographical location provided to the service provider server 4 may be periodically updated. In some embodiments, the geographical location is updated when the user is interacting with the user application 27—this may be periodically during the interaction and/or for a predetermined period after an interaction with the user application 27.

The user device 2 is configured (e.g. using the user application 27) to receive information from the item database 472 and to display at least some of that information to the user via the user device display 22. The information received from the item database 472 may include any and/or all of the information uploaded by the merchant device 3 to the item database 472.

The sending of information to the user device 2 may be triggered by any one or more of a number of different events: for example, the user device 2 may enter a predetermined range of an item and/or service listed in the item database 472, the user device 2 may submit a search query to the service provider server 4, the merchant may upload information about a new item and/or service, the user application 27 may authenticate itself with the system 1, a predetermined period may have passed since the last use of the user application 27, or the like. Accordingly in some instances, information from the item database 472 may be pushed to the user device 2 and, in some instances, information may be pulled to the user device 2 by the actions of the user.

The information displayed on the user device display 22 from the item database 472 may be displayed in a number of different forms. For example, the information may be presented as one or more icons on a map, the locations of the one or more icons on the map may be determined by location information associated with the or each item and/or service in the item database 472—i.e. one or more items and/or services may be represented by icons.

In some embodiments, the user device 2 is configured (e.g. using the user application 27) to present to the user on the user device display 22 a request for a search term. The user may, in response to such a request enter one or more search terms, e.g. using the user device interface 21. In some embodiments, the or each search term may be used by the user application 27 to filter the information received from the item database 472 based on the or each search term. In some embodiments, the or each search term may be sent to the service provider server 4 (via the network 6) and the service provider application 47 may be configured to use the or each search term to provide information from the item database 472 to the user device 2—that information being determined to be relevant to or otherwise associated with the or each search term. The information which is provided to the user device 2 may be displayed to the user via the user device display 22.

In some embodiments, the user device location module 25 is configured to output the geographical location of the user device 2 to the service provider server 4 (which may be stored in the account database 471). The service provider application 47 may be configured to use the geographical location to provide information from the item database 472 to the user device 2—that information being determined to be relevant to or otherwise associated with the geographical location. Again, that information may be displayed to the user via the user device display 22 (this may be information which is pushed to the user device 2 or information which is pulled to the user device 2 by a request issued from the user device 2). In some embodiments, the user application 27 may be configured to filter the information received from the item database 472 based on the geographical location.

Information regarding one or more items and/or services may be determined to be relevant to or otherwise associated with a search term or a geographical location based on the information for those one or more items and/or services which is stored in the item database 472. For example, the information stored in relation to an item/service may include the location of the merchant outlet in which the item/service is located.

In some embodiments, the geographical location is a region. This region may be a predetermined range from the determined geographical location of the user device 2. Accordingly, the user application 27 may be configured to prompt the user, using the user device display 22, to enter a predetermined range, e.g. using the user device interface 21. This predetermined range may be a range in metres, for example. In some embodiments, the predetermined range is uploaded by the user application 27 to the service provider server 4 and may be stored by the service provider application 47 in the account database 471 in association with account information for the user and/or user device 2.

In some embodiments, the geographical location is a building, group of buildings, or site. For example, the geographical location may be an airport, a cinema, a theatre, an arena, or the like.

In some embodiments, the information from the item database 472 is downloaded to the user device 2 where it may be browsed by the user. The information may be downloaded in response to a search term being sent to the service provider server 4, or may be downloaded in response to the user launching the user application 27, or may be downloaded in response to the user device 2 sending a refresh command to the service provider server 4 (e.g. in response to an input by the user using the user device interface 21). In some embodiments, the information may be pushed to the user device 2 by the service provider server 4—e.g. in response to the user device 2 entering within a predetermined range of an item for which information is stored in the item database.

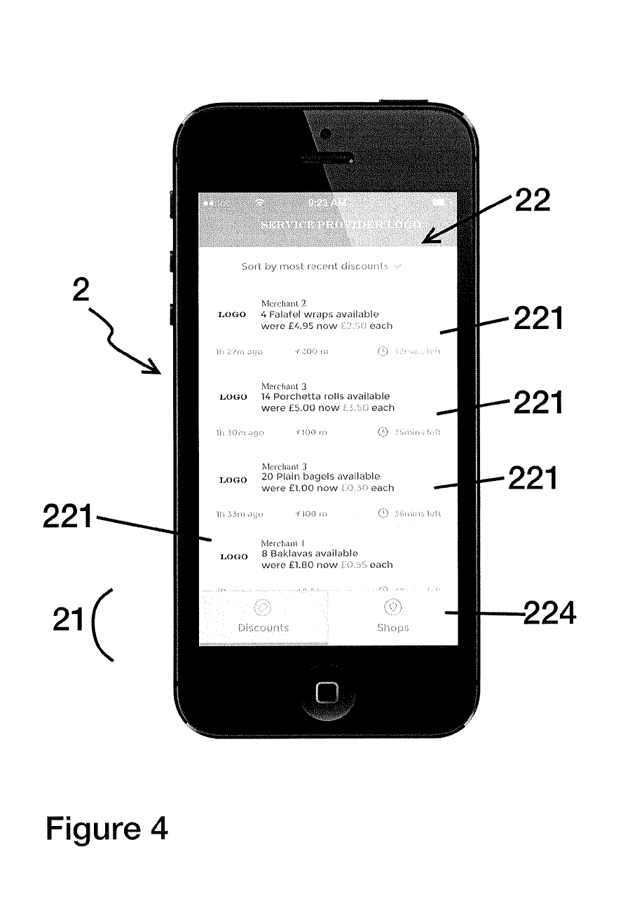

FIG. 4 shows an example graphical user interface screen which is displayed on the user device display 22. The screen includes the details of items which are advertised using the system 1, these details may include a logo associated with the merchants that uploaded the information regarding the items, sufficient information to identify the items, information about how long ago the information was uploaded, the distance of the merchant outlets (i.e. the items) from the user device 2, and the time left until the offers will no longer be available.

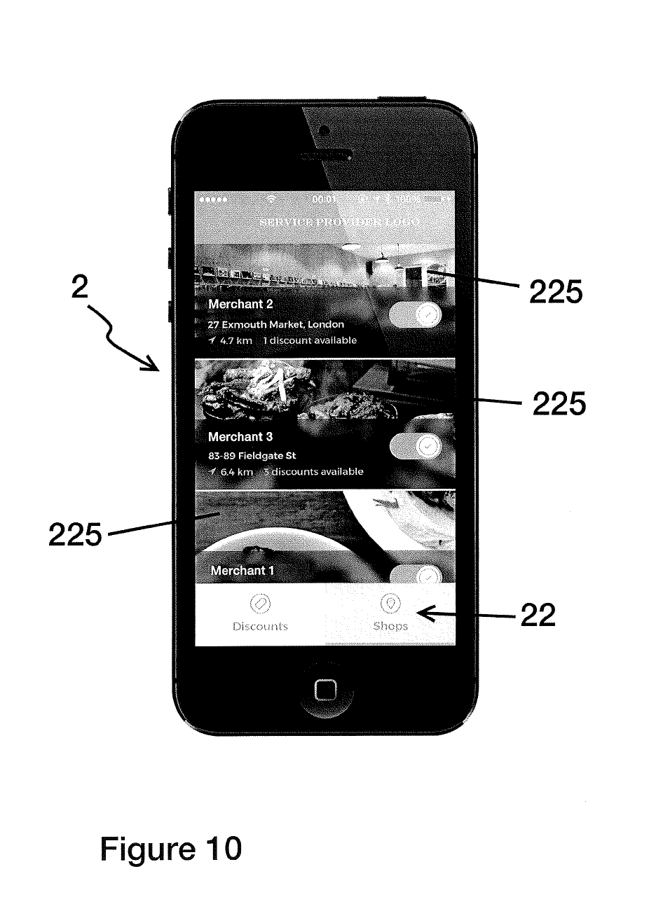

Two user actuatable buttons 224 may be provided (as part of the user device interface 21), one user actuatable button may cause the display of available items (as in FIG. 4) on its actuation and the other user actuatable button may cause the display of merchants (as in FIG. 10) on its actuation.

FIG. 10 shows an example graphical user interface screen which is displayed on the user device display 22. The screen includes the details of merchants 225 which use the system 1, these details may include a logo associated with the merchants that have uploaded information regarding items, as well as information such as address information for the merchant outlet and the distance of the merchant outlet from the user device 2.

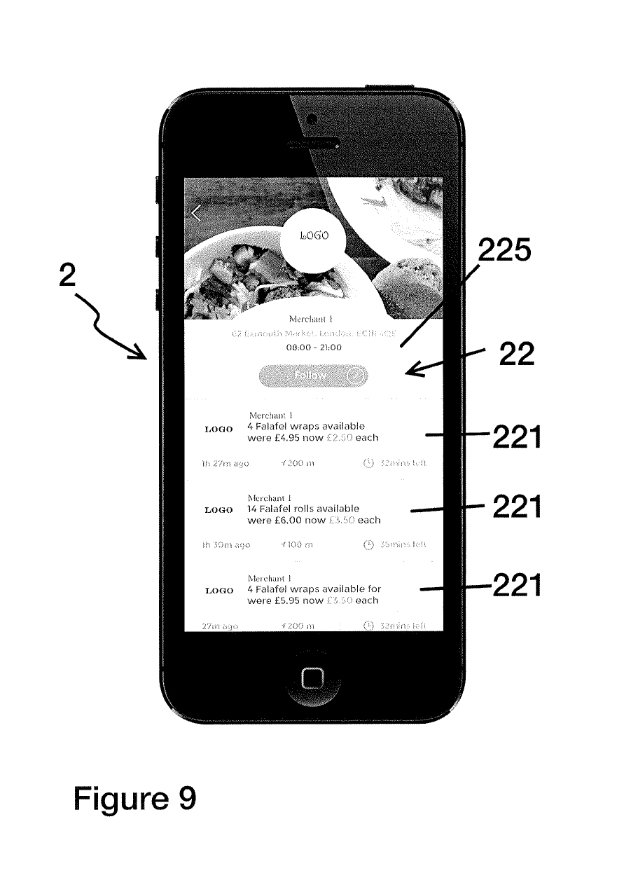

On selection of a merchant in a screen such as shown in FIG. 10, then a screen such as shown in FIG. 9 may be displayed.

FIG. 9 shows an example graphical user interface screen which is displayed on the user device display 22. The screen includes the details of a selected merchant 225, these details may include a logo associated with the merchant, as well as information such as address information for the merchant outlet and the distance of the merchant outlet from the user device 2. The screen may further include information about one or more items advertised by that merchant

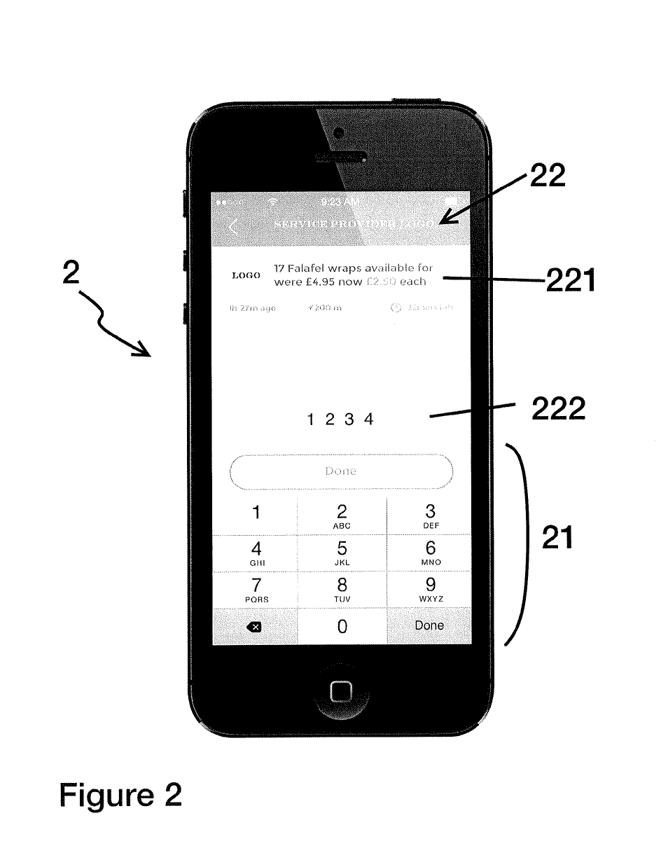

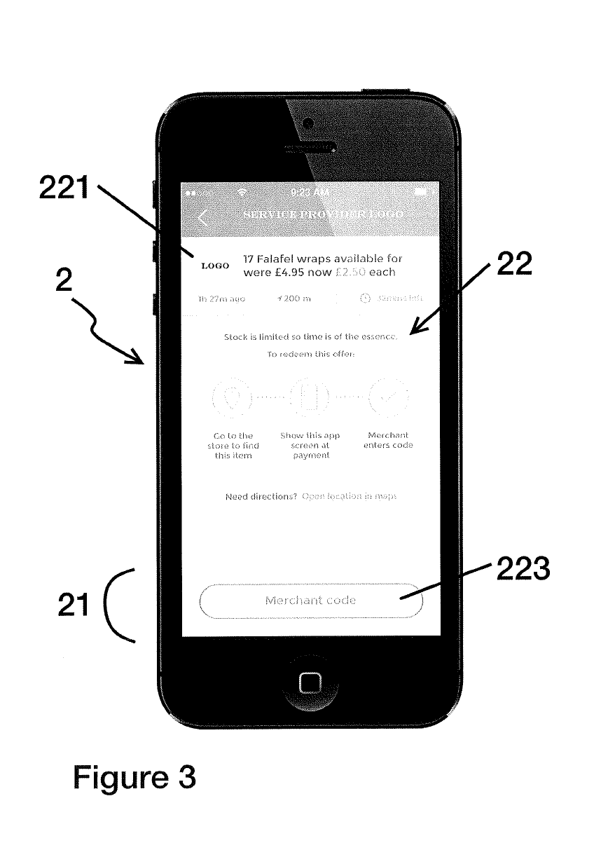

FIG. 3 shows an example graphical user interface screen which is displayed on the user device display 22. Details of the item are displayed 221 which may include a logo associated with the merchant that uploaded the information regarding the item, sufficient information to identify the item, information about how long ago the information was uploaded, the distance of the merchant outlet (i.e. the item) from the user device 2, and the time left until the offer will no longer be available. The graphical user interface screen may further display usage instructions and user actuatable button 223 (part of the user device interface 21) which, when actuated, causes the display of a further graphical user interface screen (such as shown in FIG. 2).

The information from the item database 472 may include details of the or each item and/or service at or around the geographical location of the user device 2 (e.g. within the predetermined range) which have been submitted by merchants to the service provider server 4. The or each item and/or service which is included in the information may be a subset of a plurality of items and/or services which merchants have submitted to the service provider server 4 for that geographical location—the subset being determined by one or more search terms entered by the user which may include a category of items or services. The details of the or each item and/or service may include details which are sufficient to allow a user to identify the or each item and/or service, and may include price information. The details also include the location where the or each item and/or service is available.

In some embodiments, the graphical user interface screen which is displayed on the user device display 22 includes the details of one or more items which are open to competitive bids. Accordingly, the graphical user interface screen may include an interface (e.g. a field box into which a number can be entered) through which the user can indicate a bid amount in relation to one or more items. The graphical user interface screen may further include a user actuatable button which, when actuated, causes the sending of the bid amount to the service provider server 4 and, in particular to the bid manager 473.

The bid manager 473 may return confirmation of the placing of the bid to the user device 2 and that confirmation may be displayed to the user via the graphical user interface screen.

The bid manager 473 may receive a plurality of such bids from different user devices 2 and may identify a winner in accordance with the rules for the type of auction being used (which may have been indicated by the merchant). Typically, the winner will be the user with the highest bid. The end of the auction process may be determined relative to the expiry of the goods and/or services—i.e. a predetermined period prior to expiry. In some embodiments, the end of the auction process is determined by another criteria.

The bid manager 473 may be configured, for open auctions, to output a current winning bid indicator which may include the value of the bid placed by the current winning bid and/or whether or not the reserve price has been met. This information may be output to each user device 2 for display to the user through the graphical user interface screen. Accordingly, a user may update their bid with a new bid value in an effort to be the winning bidder. Updated and new bids may be accepted by the bid manger 473 until a bid receiving period has ended (so that a final winning bid can be determined).

Accordingly, the user may be presented with the details of one or more items and/or services which are available at or around their geographical location. The user may be able to adjust the geographical range such that details of more remote (i.e. more distant) items and/or services are presented to them on their user device 2. The user may be able to adjust the geographical range such that details of more remote (i.e. more distant) items and/or services excluded from being presented to them on their user device 2.

In some embodiments, the user device location module 25 is configured to allow a user to input the geographical location manually, via the user device interface 21. Accordingly, the geographical location may not be the current geographical location of the user device 2 but could, for example, be a planned future location of the user device 2—such as the end or a stopping point on a journey.

In some embodiments, the user application 27 is configured to receive a designation of a favourite merchant. In relation to a designated favourite merchant, information about new items which are listed from that merchant in the item database 471 may be pushed to the user device 2. This may occur even if the user is not within the predetermined range of the merchant or an outlet of that merchant or the item and/or service. A plurality of merchants may be designated as a favourite merchant and which may be done via the user device interface 21 to receive the user input of the designation. A user might, therefore, designate their favourite sandwich shop or a shop which is close to their place of business or residence.

In some embodiments, the service provider server 4 and, in particular the service provider application 47, may be configured to determine the number of user devices 2 within a predetermined range of a merchant device 3 or an outlet for a merchant.

The service provider server 4 and, in particular the service provider application 47, may be configured to send details of the number of user devices within the predetermined range to the merchant device 3. This predetermined range may be set by the merchant, using the merchant device 3 and merchant application 37.

The merchant may use this information regarding the number of user devices 2 in the vicinity of the merchant device 3 (and/or outlet) to determine when to upload information about a new item to the service provider server 4 and/or what discount to apply to the item—for example, the more user devices 2 in the vicinity of the merchant device 3 (and/or outlet) the more likely the merchant will be able to sell the item and the lower the discount required to seek to ensure the items are sold.

In some embodiments, once the expiry date for an item has passed, the item and/or service information is made unavailable and may not be sent to a user device 2. In some embodiments, the merchant is able to provide an indication of a period during which the offer is available and the item and/or service may be made unavailable and may not be sent to a user device 2 once this period has passed.

In some embodiments, the item database 472 is periodically purged of information which was uploaded more than one week ago, or more than five days ago, or more than three days ago, or more the two days ago, or more than one day ago. In some embodiments, the items database 472 is periodically purged of information relating to items wherein the expiry date of the items has passed. Purged information may be made unavailable to the client device 2 or may be deleted. When information is purged, that information may be made available on a secondary system to one or more other user devices 2 which may be associated with particular types of user (for example charities, recycling organisations, local food banks and the like). The information may be pushed to the other user devices 2 when the information is purged. On receipt of the purged information the user applications 27 of the or each other user device 2 may present, on the user device display(s) 22, at least a portion of the purged information and the option for the user to reserve the or each item in much the same way as for the normal users prior to the information being purged. The price of the or each item detailed in the purged information (to the or each other type of user) may be negligible or nothing.

The user application 27 may be configured to receive an indication from the user (for example, via the user device interface 21) of a selection of one or more of the items and/or services, the details of which are presented to the user.

On selection of one or more items and/or services, the user application 27 may be configured to send a reserve request to the service provider server 4 and, in particular, to the service provider application 47 over the network 6.

In embodiments involving competitive bidding, the reserve request may be issued by the bid manager 473 on conclusion of an auction. In some embodiments in which there is competitive bidding, each bid made by a user results in a reserve request being issued; however, the reserve requests are channelled through the bid manager 473 which is configured to output the reserve request for the winning bid but to decline the other reserve request (which may result in notifications being sent to the user devices 2 of the users who placed bids regarding the success or otherwise of their bid).

In response to the reserve request, the service provider application 47 may forward the reserve request to the merchant device 3 and, in particular, to the merchant application 37. In addition or alternatively, the service provider application 47 may mark the entry associated with the or each respective items and/or services to which the reserve request relates with an indication that the item and/or service has been reserved.

In some embodiments, the user application 27 may be configured to pass location information for the or each item and/or service to another application executing on the user device 2 such as a navigation program. The navigation program may then be configured to navigate the user to the location of the item and/or service (e.g. by displaying directions on the user device display 22). In some embodiments, the user application 27 itself is configured to navigate the user to the location (e.g. by the provision of direction information).

The user may then, for example, visit the merchant outlet at which the or each reserved item and/or service is located and purchase the or each item and/or service from the merchant. On the purchase of the or each item and/or service, the user application 2 may display, using the user device display 22 for example, a request for the merchant to enter transaction information into the user device 2 (using the user device interface 21 for example). An example graphical user interface screen presented on the user device display 22 is depicted in FIG. 2. In FIG. 2, details 221 of the item are displayed along with a field 222 for entry of the transaction information. A portion of the user device display 22 provides the user device interface 21.

On entry of the transaction information (e.g. in the form of a code), the user application 27 may send a purchase message to the service provider application 47 over the network 6. On receipt of the purchase message the service provider application 47 may be configured to mark the or each item and/or service as purchased. This may then be removed from the item database 472 or may be made unavailable to other user devices 2 in future requests for information about one or more items and/or services.

The transaction information may be generated by the service provider application 47 and sent to the merchant application 37 on the receipt of the reserve request by the service provider application 47. The transaction information may then be presented to the merchant on the merchant device display 32, for example.

In some embodiments, the user application 2 may be configured to display transaction information (e.g. a code) on the user device display 22 which the merchant can then enter into the merchant device 3 (e.g. using the merchant device interface 31). This information may then be sent by the merchant application 37 to the service provider server 4 as part of the purchase message—which then causes the removal or making unavailable of the information about the one or more items and/or services as discussed above. The transaction information in such embodiments may have been generated by the service provider application 47 and sent to the user application 27.

In some embodiments, the transaction information (e.g. code) is unique or substantially unique to that item and/or purchase (which may be of a plurality of items and/or services).

In some embodiments, the merchant application 37, user application 27, and/or service provider application 47 is configured to cause the reserve request to expire if a predetermined period elapses before a purchase message is sent/received. This predetermined period may be set by the merchant in the information about the item which is provided by the merchant for uploading to the service provider server 4. The predetermined period may end when the expiry date of the item passes.

In some embodiments, service provider application 47 may be configured to store payment information for the or each user and account information for the or each merchant. On receipt of a reserve request, the service provider application 47 may be configured to debit funds using the payment information for the user and to credit the account information for the merchant who uploaded the information about the or each item and/or service. This may equally be done on receipt of the transaction information by the service provider application 47.

Accordingly, in some embodiments, the user may reserve one or more items and/or services for purchase, and the purchase of the or each item and/or service is facilitated in a conventional manner in accordance with the merchant's normal payment methods (e.g. using cash in the merchant outlet or a credit/debit card payment method). In other embodiments, however, the payment is made using the system 1.

In some embodiments, the user device 2 includes a mechanism for delivering payment information to the merchant device 3 and/or to a point of sale system for the merchant. This may include a contactless payment mechanism which may use RFID tags and/or a Near Field Communication tags (i.e. a very short range radio frequency communication system). The RFID or NFC tag may form part of the user device 2 and include payment information associated with a user account via which payments can be made.

As will be appreciated, therefore, merchants can use the system 1 to advertise one or more items and/or services for sale at discounted prices to users of the system 1. These one or more items and/or services may be items or supplies for services which are approaching or close to their expiry date and which, therefore, the merchant is considering disposing of as waste or returning to a supplier or distributor. In some instances, the or each item expires on the day on which it is advertised using the system 1.

Items which are approaching or close to their expiry date may be generally referred to as spoiling items (as they are approach then end of their shelf-life and may be starting to spoil to a degree at which they shortly cannot be sold). In some examples, an expiry date is the last date on which the item can be sold or used in accordance with health and safety legislation.

The use of a merchant device 3 to upload information about the or each item and/or service allows information to be uploaded in a simple manner using, in some embodiments, a conventional computing device. Accordingly, in some embodiments, merchants need not invest capital in new equipment.

Users are presented with a mechanism by which they can identify such items and/or services. The users can use features such as adjustment of the predetermined range, and search terms, to identify items and/or services which are of interest and which are likely to be available for sufficient time for the user to reserve the item and/or service.

In some embodiments, the user device 2, for example through the user application 27, is configured to send a social network update over the network 6 to the social network server 5. The social network update may be received via the API 51 and provided to the social network application 57 along with details of the user's social network account (which may also be sent by the user application 27). The social network update may include information about the or each item and/or service and may include a copy of or a link to information about the or each item and/or service which was received from the service provider server 4. The user application 27 may be configured to allow the user to input additional information, such as a comment, as part of the social network update (e.g. via the use of the user device interface 21). The user may, therefore, update a social networking page, feed, or stream with which they are associated with details of the or each item and/or service. This may encourage other users to take advantage of a discount offer advertised using the system 1, for example.

Similarly, the merchant application 37 may be configured to allow merchants to make social network updates which may be used as further advertising of the offers which they are advertising using the system 1.

The social network application 57 may be configured to receive these updates and to display the updates in the conventional manner. The or each social network update may be displayed in association with a social network which is related to the system 1.

In some embodiments, the login information which is required to access the user application 27 and/or the merchant application 37 is the same as login information for a user or merchant social network account. As such, the submission of login information to the service provider server 4 may cause the submission, by the service provider server 4, of the login information (or a part thereof) to the social network server 5. The social network application 57, via the API 51, may authenticate the user or merchant using the login information and send confirmation of the authentication to the service provider server 4 which then determines that the user or merchant is duly authorised to us the system 1. In other embodiments, the login information is sent from the user or merchant device 2,3 to the social network server 5 for authentication and the social network server 5 may forward login information to the service provider server for authentication of the user or merchant in relation to the system 1.

The social network application 57 may be a blogging or microblogging application, for example.

In some embodiments, the user device 2, for example through the user application 27, is configured to send a courier request over the network 6 to the courier server 7. The courier request may be received via the courier API 71 and provided to the courier application 77 along with details of the user and/or the user device 2 (e.g. login information) which may also be sent by the user application 27. The courier request may include information about the or each item and may include a copy of or a link to information about the or each item which was received from the service provider server 4. This information may include the location of the item (i.e. the location of the merchant outlet at which the item is located). The user application 27 may be configured to allow the user to input additional information, such as a comment or instructions, as part of the courier request (e.g. via the use of the user device interface 21). In some embodiments, the courier request is sent directly to the courier server 7 but in others the courier request is sent via the service provider server 2.

The courier request may be a request for a courier to collect the or each item from the merchant outlet at which the item is located and to deliver the item to another location. Accordingly, the courier request may include details of the other location—which may be a residence or place of work for the user.

The courier may, using the courier application 77 accept a courier request and/or return a quote to the service provider server 2 for completing the task set out in the courier request. This quote may be returned to the user device 2 by the service provider server 4 and may be displayed on the user device display 22. The user may also be prompted, via the user device display 22, to accept or not the quotation. The response may be sent to the courier server 7 via the network 6 (and possibly also the service provider server 2 in some embodiments). On receipt of acceptance of the quotation, then this may be presented by the courier application 77 to the courier, who may then perform the courier task by, for example, collecting the item from the merchant outlet and delivering the item to the requested other location.

Payment for the use of the courier may be achieved through the payment mechanism discussed herein in relation to transactions between the user and the merchant (including, for example, the use of a transaction code).

In some embodiments, the user device 2 is configured to send a message (which may have been written by a user using the user device interface 21) to a particular merchant device 3. This may be achieved by the sending of the message to the service provider server 4 and, in particular, to the messenger application 48. The messenger application 48 may be configured to receive the message, to read at least a part of the message (e.g. a header) to determine the intended destination of the message (e.g. a particular merchant device 3 or merchant) and to forward the message to the intended destination (e.g. over the network 6). The merchant device 37, in particular the merchant application 37, may be configured to receive the message and to display the message to the merchant (e.g. on the merchant device display 32). Each of the user device 2 and the merchant device 3 may, therefore, include a message handling facility as part of the user application and merchant application 27,37—which may include records of historic messages and the like. The message may be associated with a particular item which the merchant has on offer and may, therefore, include information about that item (e.g. in the message header). This may allow messages to be classified according to the item to which they relate and/or according to other information associated with the item (such as expiry date, location, etc.).

In some embodiments, the information about one or more items which is uploaded from the merchant device 3 may include price decay information. The price decay information may be a rate at which the price of the or each item will decay (i.e. at which the discount offered in relation to the or each item will increase) over time. The uploaded information may also include one or both of an initial price or discount and a final price or discount. Thus, the merchant may indicate that the discount/price for the or each item is to start at the initial price/discount and that the price decay information is to operate over a period of time until the final price/discount is reached. If no initial price/discount is indicated then the initial price or discount may be full price (i.e. no discount). If no final price/discount is indicated then the price decay information be operate until the or each item is removed from offer through the system 1 (e.g. when the or each item finally expires, is purchased, or is otherwise removed) or until the price reaches zero in some embodiments.

Therefore, in some embodiments, an initial discount of 25% may be offered and the price decay information indicating an additional 2% discount is to be applied every hour from when the information is uploaded. When the user selects that item, then the discount which had been reached at that time will be applied.

In some embodiments, the information which is uploaded about the or each item includes a price decay deal factor—which is a period of time after the uploading of the information before the price decay information operates.

The discount/price may be updates in the information which is presented to the user via the user device display 22 and may also be updated (or dynamically determined) in the service provider application 47.

This aspect of some embodiments, helps to avoid merchants having to update discounts/prices manually, allows discounts/prices to be varied over a period of time, and encourages user interaction and interest—there being a balance between leaving the selection and reserving of the item for as late as possible and leaving it too late such that another user selects and reserves the item first.

In some embodiments, the price decay information may be dynamically and automatically adjusted by the merchant application 37 and/or by the service provider application 47 in response to one or more factors. For example, the sale of other items by the same merchant may reduce or increase the price decay rate. Similarly, the price decay rate may be increased or decreased dependent on the number of users to which information about the item is sent and/or the length of time users view information about an item—which may be recorded by the user application 27 and sent to the service provider application 47. Such adjustments may help to maximise the price which the merchant is able to obtain for the item.

In some embodiments, the price decay information may, in fact, indicate that the price should be inflated (i.e. the discount reduced) and this may operate in the same manner as the decay of the price described above—including the dynamic and automatic adjustment thereof. This may encourage users to select and reserve items more quickly.

In some embodiments, a VIP service is provided. Accordingly, a user and/or merchant may qualify for VIP service due to the number of uses of the system 1, the number of items purchased and reserved, the length of time as a user, the payment of a VIP membership fee to the service provider, or some other factor. In some examples, a user may qualify for VIP service through a frequent flyer scheme—i.e. all members of the scheme may be eligible or only members over a certain number of frequent flyer reward points/miles may be eligible.

In accordance with the VIP service, a user device 2 of the user may receive information about one or more items in advance of other user devices 2 (whose users are not part of the VIP service). Accordingly, when a merchant uploads information to the item database 472, that information may be available for sending to one or more user devices 2 with the VIP service for an initial predetermined period (e.g. in response to a request from the user device 2 or pushed to the user device 2). After the initial predetermined period has passed then the information may be available for sending to one or more user devices without the VIP service. Accordingly, the information is excluded from the information accessible by the or each user device 2 without the VIP service for the initial predetermined period, in such embodiments.

A merchant with the VIP service may, in some embodiments, be able to have information about one or more items that has been uploaded to the item database 472 pushed to one or more user devices 2 which would not otherwise be pushed the information, or the information may be ranked about information about one or more items which have been uploaded by merchants not using the VIP service.

Whether or not a user or a merchant has the VIP service may be stored in the account database 471.

In some embodiments, information about the purchases which are made by users through the system 1 is recorded in the account and/or item database 471,472 for later analysis. In some embodiments, this information is transferred to a further database. The stored information may be tokenised, simplified, or otherwise anonymised. This may be used to determine user and merchant behavioural trends, for example.

In some embodiments, the merchant application 37 is configured to prompt the merchant to enter information about one or more other items (not advertised through the system 1) which were also purchased or collected by/for the user at the same time as a reserved item advertised through the system 1 is collected or purchased. The merchant application 37 may be configured to receive information about these one or more other items through the merchant device interface 31—using any of the mechanisms described above including the image capture device and/or barcode reader for example but also including manual entry. This addition information may be uploaded by the merchant application 37 to the service provider server 4 and, in particular, to the service provider application 47. The service provider application 47 may store the additional information in the account and/or item database 471,472 for later analysis.

As will be understood, the term “merchant” has been used herein to indicate the seller of items (i.e. products or goods) and also the supplier of services which may use items in the supply of those services. The merchant has one or more items and/or services for supply or provision to a user. In some embodiments, a user may be another merchant. In some embodiments, a merchant may be another user. Accordingly, embodiments of the present invention may be used to allow for the advertisement (and maybe also the sale) of items and/or services between consumers. Equally, embodiments of the present invention may be used to allow for the advertisement (and maybe also the sale) of items and/or services between merchants. A consumer, in this instance, being a user whose main occupation is not the sale of items and/or services of the type advertised. A merchant, in this instance, being a user whose main occupation is the sale of items and/or services of the type advertised.

Embodiments of the present invention may be particularly useful in relation to items which comprise food—e.g. sandwiches, fruit, and the like. Embodiments of the present invention may also be useful in relation to other items which may have an expiry date (for example, some engine oils, brake fluids, or the like, as well as medical drugs, ointments, flowers, and the like).

Embodiments of the present invention may be particularly useful in relation to items which comprise printed publications (such as magazines, newspaper, and the like). Editions of such publications may be issued on a regular/periodic basis (e.g. daily, weekly, monthly, etc.). In the example of books the new editions may be issued periodically rather than regularly. Shortly prior to a new edition going on sale, old editions are typically removed from sale. Therefore, embodiments of the present invention could be used in relation to old editions of printed publications and the old editions are close to their expiry in the sense that they will shortly need to be removed from sale to make way for the new editions.

Embodiments of the present invention may be particularly useful in relation to items which comprise tickets and/or passes for events or journeys—such as music concerts, festivals, the ballet, the opera, boxing, soccer matches, baseball matches, (American) football matches, ice hockey games, basketball games, other sporting events, audience seats for television shows, museum tours, journeys by aircraft, boat/shop journeys, bus/coach journeys, train journeys, and the like. Such events and journeys often have schedules or a scheduled for particular days and/or times. Accordingly, the expiry of these tickets and/or passes may be the last day/time that the ticket and/or pass can be used.

Thus, for example, on a merchant becoming aware of a space for a particular journey becoming available (e.g. a cancelled ticket or a no-show), the merchant may make that space available using embodiments of the invention. In some embodiments, the space may be made available to users who are able to take that space. For example, the space may be a seat in an aeroplane (i.e. “airplane”) which may be in a particular class. The space may be made available to users who are waiting to travel without a reservation (e.g. to fly standby) or may be made available to users who are already due to travel on the same journey but in a different class or seat, for example. The user may, therefore, be able to purchase the advertised (i.e. offered) space using embodiments of the invention. In the event that the user already had a space on the same journey, then that user's space may then be made available through embodiments of the invention, once they have purchased the advertised space. The same may apply to attendance at events (e.g. concerts, plays, and sporting events), journeys (e.g. flights, train travel, travel by ship or boat, and the like), and accommodation (e.g. hotels, and the like).

As will be understood, the use of embodiments to provide users with alternative options for goods and/or services which they were already intending to receive, may create a chain of reallocated goods and/services as users take different goods and/or services, and allow their original goods and/or services to be advertised through embodiments.

In some such embodiments, restrictions are imposed to prevent users from swapping from one service to another. Accordingly, it may only be possible for users to purchase different levels or types of the same service. Thus, for example, a user may be prevented from changing flights. This may be for security and/or baggage handling requirements, for example.

Embodiments of the present invention may provide a system 1 by which multiple different merchants (who may have no financial links) can advertise items and services through a user application 27 to multiple different users. In other embodiments, the whole or part of the system 1 may be provided as a merchant specific system. In some such embodiments, the entire system may be accessible by one merchant (that may have multiple merchant outlets, multiple merchant devices 3, etc). In some such embodiments, the user applications 27 may be merchant specific, such that a particular user application 27 can access only items and/or services for which information has been uploaded by one merchant (that may have multiple merchant outlets, multiple merchant devices 3, etc). The user device 2 may, therefore, include a plurality of user applications 27, with at least one of the user applications 27 being a merchant specific user application 27 for a first merchant (another of the user applications 27 may be merchant specific for a second merchant or may be a non-merchant specific user application 27).

In some embodiments, there may be a service provider API provided as part of the service provider application 47 which allows one or more other programs and/or services to communicate with the service provider application 47 to download and/or upload information from the service provider server 4 (e.g. information from the item or account database 471,472).

The term “expiry date” has been used herein for convenience and may be a reference to a date and/or to a time on a date.

In some examples, an expiry date is the time of departure of a form of transportation. As will be appreciated, in many instances, the possibility of new users purchasing tickets for the form of transportation may be in advance of the time at which users who have already purchased tickets may be able to upgrade or change their tickets using embodiments. However, the time period in which such transactions can take place may be restricted—e.g. less than an hour or even less than half-an-hour.

In some embodiments, upgrades may be advertised through embodiments of the invention even when there has been no earlier cancellation. For example, priority services (such as priority boarding for flights) may be advertised through embodiments of the invention. In some examples, the expiry date may be the last possible opportunity to use the goods or services. In the example of priority boarding advertised through embodiments, this may be offered up until boarding of the aircraft is complete. Accordingly, if a flight is busy and there is a large queue for boarding, users may be more inclined to purchase priority boarding and/or may be minded to pay more for priority boarding. As will be appreciated, a limited number of places may be offered (for services) through embodiments—e.g. a limited number of priority boarding places may be offered.

Embodiments may also be used in relation to items which are not approaching or close to their expiry date.

In some embodiments, at least one of the service provider server 4 and the merchant device 3 is configured to be communicatively coupled to one or more editable labels associated with the or each item for which information has been uploaded from the merchant device 3. The or each editable label may form part of the system 1. The or each editable label may be a visual label which includes a screen which is configured to display information (which may be part of the information uploaded to the service provider server 4). The or each editable label may include a short range (e.g. Bluetooth) or extremely short range (e.g. NFC or RFID tag) communication system which is configured to relay at information (which may be part of the information uploaded to the service provider server 4) to a user device 2 in close proximity to the or each editable label. The information which is displayed or relayed may include the current price or discount (including any price decay, for example) at which the item is available through the system 1. The editable label may prompt the user (directly or via a user display) to access the system 1 to select the item (e.g. to reserve and/or purchase the item). In some embodiments, on receipt of the information from the or each editable label, the user application 27 may present the user with the option (via the user device display 22) to select the item (e.g. to reserve and/or purchase the item).

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A system for advertising items which are close to their expiry dates, the system comprising:
a merchant device configured to upload information about an item which is close to its expiry date;
a service provider server configured to receive the uploaded information and to store the uploaded information in an item database; and
a user device configured to receive at least part of the uploaded information from the item database, to receive a user's selection of the item, and to transmit a reserve request to the service provider server, wherein the service provider server is further configured to forward the reserve request to the merchant device such that the item is reserved for the user.

2. The system according to claim 1, wherein the expiry date is the date on which the at least part of the uploaded information is received by the user device.

3. The system according to claim 1, wherein the merchant device is a mobile computing device.

4. The system according to claim 1, wherein the user device is a mobile computing device.

5. The system according to claim 1, wherein the user device includes a location module which is configured to determine the location of the user device and wherein the user device is further configured to request information about the item based on a proximity of a location of the item to the determined location of the user device.

6. The system according to claim 5, wherein the location module is configured to upload the determined location to the service provider server and the service provider server is configured to send information about the number of user devices within a predetermined range of the merchant device to the merchant device.

7. The system according to claim 1, wherein the merchant device is further configured to receive transaction information from the service provider server in response to the item being reserved for purchase, and the user device is configured to prompt for entry of the transaction information during a transaction for the item between the user and the merchant, such that the transaction information is enterable into the user device and the user device is further configured to send the transaction information to the service provider server to confirm the transaction.

8. The system according to claim 1, wherein the merchant device includes an image capture device which is configured to capture an image of the item and wherein the information which is uploaded includes the image of the item.

9. A system according to claim 8, wherein the at least part of the uploaded information which is received by the user device includes the image of the item.

10. The system according to claim 1, wherein the user device, the merchant device, and the service provider server are communicatively coupled to each other over a network which includes the Internet.

11. A method for advertising items which are close to their expiry dates, the method comprising:
uploading information about an item which is close to its expiry date using a merchant device;
receiving the uploaded information and storing the uploaded information in an item database using a service provider server;
receiving at least part of the uploaded information from the item database using a user device;
receiving a user's selection of the item at the user device; and
transmitting from the user device a reserve request to the service provider server; and
forwarding the reserve request from the service provider server to the merchant device such that the item is reserved for the user.

12. The method according to claim 11, wherein the expiry date is the date on which the at least part of the uploaded information is received by the user device.

13. A non-transitory computer readable medium having instructions stored thereon in the form of a client application which, when executed by a processor of a user device, cause the user device to:
transmit a request for information from a service provider server about an item which is close to its expiry date;
receive information from the service provider server about the item;
receive a user's selection of the item; and
transmit a reserve request to the service provider server.

14. The non-transitory computer readable medium according to claim 13, wherein the expiry date is the date on which the information is received by the user device.

15. The non-transitory computer readable medium according to claim 13, wherein the instructions, when executed by the processor, further cause the user device to:
display a request for the entry of transaction information;
receive entered transaction information in response to the displayed request; and
transmit the transaction information to the service provider server to confirm the transaction has occurred.

16. A non-transitory computer readable medium having instructions stored thereon in the form of a merchant application which, when executed by a processor of a merchant device, cause the merchant device to:
upload information to a service provider server about an item which is close to its expiry date; and
receive a reserve request for the item from the service provider server.

17. The non-transitory computer readable medium according to claim 16, wherein the expiry date is the date on which the information is uploaded by the merchant device.

18. The non-transitory computer readable medium according to claim 16, wherein the instructions, when executed by the processor, further cause the merchant device to:
receive transaction information from the service provider server such that the merchant can provide the transaction information to a user device; and
receive confirm of the completion of the transaction from the service provider server in response to the merchant providing the transaction information to the user device.

19. A non-transitory computer readable medium having instructions stored thereon in the form of a service provider application which, when executed by a processor of a service provider server, cause the service provider server to:
receive uploaded information from a merchant device about an item which is close to its expiry date;
store the uploaded information in an item database;
send at least part of the uploaded information from the item database to a user device;
receiving a reserve request from the user device in relation to the item; and
forwarding the reserve request to the merchant device such that the item is reserved for the user.

20. The non-transitory computer readable medium according to claim 19, wherein the expiry date is the date on which the at least part of the uploaded information is received by the user device.
